(19) United States
(12) Patent Application Publication
(10) Pub. No.: US 2024/0391117 A1
(43) Pub. Date: Nov. 28, 2024

(54) Modified and Modernized Ulu

(71) Applicant: Douglas Katz, Willowbrook, IL (US)

(72) Inventor: Douglas Katz, Willowbrook, IL (US)

(21) Appl. No.: 18/202,691

(22) Filed: May 26, 2023

(51) Int. Cl. B26B 1/04; B25G 1/06; B25G 1/10; B26B 11/00

(52) U.S. Cl. CPC B26B 1/04; B25G 1/06; B25G 1/102; B26B 11/006

(57) ABSTRACT

An embodiment includes a cutting tool having a multi-grip handle. The multi-grip handle includes an end grip surface and a pair of grip surfaces. The cutting tool includes a connecting region having a first cutting edge, where the pair of grip surfaces are positioned between the end grip surface and the first cutting edge. The cutting tool includes a blade connected to the multi-grip handle via the connecting region and having a second cutting edge.

### CROSS-REFERENCE TO RELATED APPLICATIONS

None.

### BACKGROUND

Cutting tools in the form of an ulu are conventionally formed with a curved main cutting edge or blade and a handle positioned opposite the cutting edge or blade, centrally located. A conventional handle location, i.e., central to the main cutting edge, ensures that the force is applied near the middle of the blade, differentiating it from other knives or cutting tools that feature a handle at one end of the blade. This feature of the ulu design also facilitates one-handed use.

### SUMMARY

In summary, an embodiment provides a cutting tool, comprising: a multi-grip handle including: an end grip surface; and a pair of grip surfaces; a connecting region having a first cutting edge; the pair of grip surfaces being positioned between the end grip surface and the first cutting edge; and a blade connected to the multi-grip handle via the connecting region and having a second cutting edge.

In an embodiment, the blade comprises a third cutting edge positioned between the first cutting edge and the second cutting edge.

In an embodiment, the blade, in a first position, runs parallel to the multi-grip handle and lengthwise away from the connection region underneath the multi-grip handle.

In an embodiment, the cutting tool comprises a hinge disposed at an end of the multi-grip handle in the connecting region.

In an embodiment, the blade is repositionable about the hinge to angle towards and away from the multi-grip handle.

In an embodiment, the blade is repositionable with respect to the multi-grip handle at one or more predetermined angles.

In an embodiment, the one or more predetermined angles are within the range of about 20 degrees to about 45 degrees.

In an embodiment, the one or more predetermined angles is about 180 degrees.

In an embodiment, the cutting tool comprises a fourth cutting edge disposed on the blade opposite to the second cutting edge.

In an embodiment, the cutting tool comprises one or more tools disposed on one or more of the multi-grip handle, the connecting region, and the blade.

In an embodiment, the one or more tools include one or more of a bottle opener, a hook, and a light emitting diode (LED) operatively connected to a power source.

In an embodiment, the multi-grip handle is angled with respect to the blade in a fixed position.

In an embodiment, the fixed position is an angle in the range of about 20 degrees to about 45 degrees.

In an embodiment, the multi-grip handle comprises contouring.

In an embodiment, the contouring is defined by one or more of the pair of grip surfaces.

An embodiment provides a cutting tool, comprising: a handle including a pair of grip surfaces; a connecting region; a hinge; and an ulu blade connected to handle via the connecting region and having a cutting edge; the hinge being disposed at an end of the handle in the connecting region.

In an embodiment, the ulu blade is repositionable about the hinge to angle towards and away from the handle.

In an embodiment, the ulu blade is repositionable with respect to the handle at one or more predetermined angles within the range of about 20 degrees to about 180 degrees.

In an embodiment, the ulu blade comprises a second cutting edge opposite the cutting edge.

In an embodiment, the second cutting edge is smooth.

In an embodiment, the second cutting edge is serrated.

The foregoing is a summary and thus may contain simplifications,

generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

FIG. 1 illustrates an example cutting tool.

FIG. 2A, FIG. 2B, FIG. 2C, and FIG. 2D illustrate examples of a cutting tool and respective holding or grasping orientations.

FIG. 3A and FIG. 3B illustrate examples of a cutting tool with a handle being repositioned about the blade.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “in an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, etc. In other instances, well-known structures, materials, or operations are not shown or described in detail to avoid obfuscation.

Conventional knives have a blade that is basically an extension of the hand, with a linear design of a handle with a blade on the end. This reduces the cutting power and puts stress on the user, e.g., on joints required for the cutting. Consequently, conventional knife designs require the use of significant force and effort, opening the possibility of injury, particularly with repetitive use such as found in food service industry workers.

Moreover, conventional knife configurations, even conventional ulu designs, make use of the knife difficult or impossible for any users with disabilities that impact the wrist, elbow, or hand, as central or side handle placements offer respective disadvantages. Typically, users will resort to identifying multiple cutting tools that suit different purposes and that are comfortable. Often, this leads users to obtain multiple knives or cutting tools of different design.

An embodiment provides an ulu style knife. In an embodiment, a handle is provided. In an embodiment, the handle may be angled to move the fulcrum point of musculoskeletal connection to the side of the main cutting edge or blade, allowing for better transfer of force from the user to the cutting edge.

An embodiment includes an ergonomic multi-grip handle that allows the user to flexibly use multiple cutting edges, offering greater utility. In an embodiment, the multi-grip handle may be oriented at one or more predetermined angles with respect to the main cutting edge or blade. In an embodiment, the multi-grip handle is provided at a fixed angle, for example by forming a base or central part of the multi-grip handle and the blade from a single piece of material such as steel.

An embodiment provides the user with multiple cutting edges and/or associated tools or accessories, permitting full leverage of the multi-grip handle for cutting, slicing, and chopping, as well as use of the associated tool(s) provided.

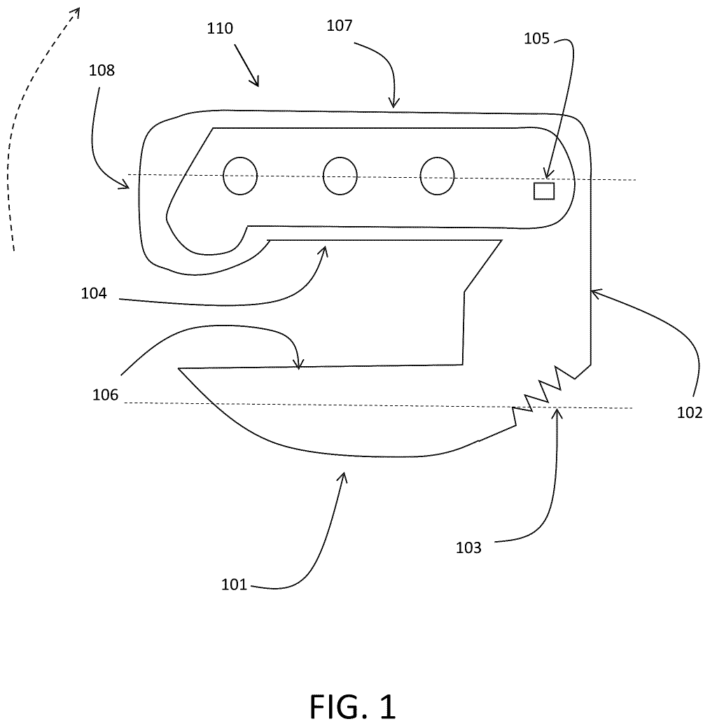

Referring to FIG. 1, an embodiment provides a cutting tool that takes the general form of an ulu knife, as illustrated. In the example of FIG. 1, a multi-grip handle 110 is provided such that a user may grasp the cutting tool in various manners to facilitate use of multiple cutting edges or tools/accessories, as further described herein.

Multi-grip handle 110 includes a pair of grip surfaces, as shown a grip surface 104 and a grip surface 107, that allow a user to grasp multi-grip handle 110 for use as an ulu style cutting tool via connection of multi-grip handle 110 and a blade having a main cutting edge 101. In an embodiment, multi-grip handle 110 and the blade having main cutting edge 101 are connected via a connecting region having a cutting edge 102 and one end, whereas multi-grip handle 110 and blade having cutting edge 101 are not connected at another end, forming an opening for entry of the user's hand.

Main cutting edge 101, which may be curved as illustrated, is provided opposite multi-grip handle 110 for slicing or cutting. Although a curved cutting edge 101 is illustrated as substantially smooth, it may include serrations or teeth throughout, like those shown at area 103. The area 103 may be formed as a cutting edge and provided at varying angles, for example about 115 degrees to about 145 degrees with respect to cutting edge 102. Similarly, while surfaces illustrated herein, such as grip surface 104 and grip surface 107 are straight, these may be contoured, for example to match a user's finger positions when grasping multi-grip handle in various orientations, as further described herein.

One or more embodiments may include a variety of dimensions. For example, an embodiment may include a blade that has a maximal width dimension between cutting edge 101 and surface 106 of about 1.5 inches to about 3 inches or about 2 inches to about 4 inches, an opening defined between surface 106 and grip surface 108 of about 1 inch to about 2 inches, and a multi-grip handle width of about 1 inch to about 2 inches. The blade may have a length of about 6 inches to about 10 inches. The multi-grip handle may have a length of about 7 inches to about 10.5 inches.

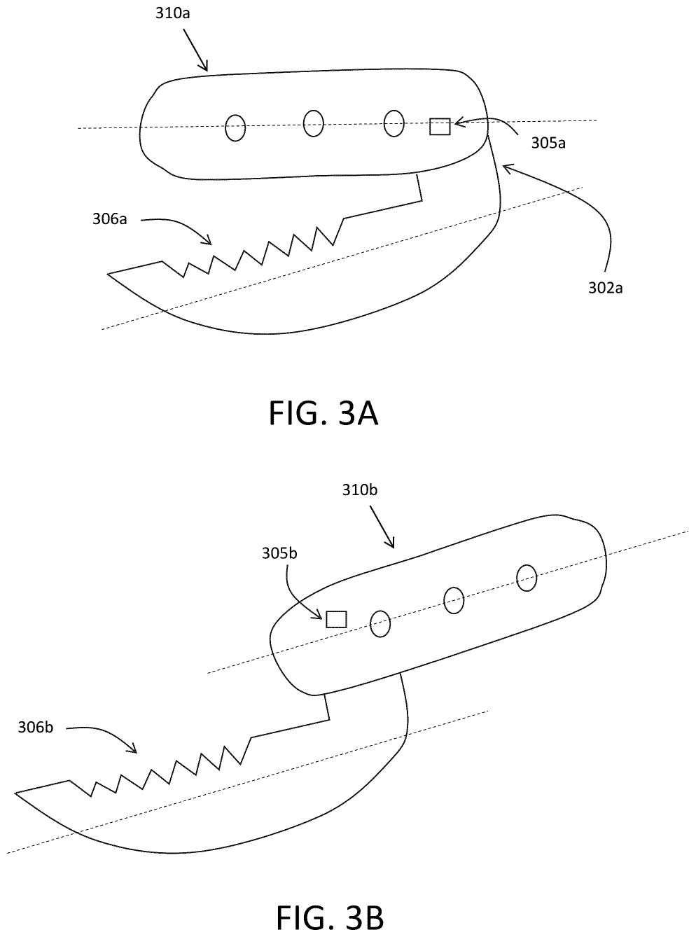

Multi-grip handle 110 may be angled with respect to the blade comprising main cutting edge 101, for example as noted by the axes illustrated for each, indicated by the dashed lines in FIG. 1 and FIG. 3A-B. As described herein, multi-grip handle 110 and blade having cutting edge 101 may be angled with respect to one another as defined by the angular orientation of each axis. In FIG. 1, a parallel arrangement of axes is illustrated, although this relationship may be modified, e.g., using a fixed angle such as in the range of about 20 degrees to about 45 degrees, or an adjustable angle may be utilized.

In the example illustrated in FIG. 1, the cutting tool may include adjustable multi-grip handle 110 that moves about a hinge or similar element 105, such as used in a lock-blade knife. This permits multi-grip handle 110 to be positioned at one or more predetermined angles relative to the blade, i.e., repositioned by rotation about hinge 105 as indicated generally in FIG. 1 by dashed arrow. In one example, a fixed angle or an adjustable angle via hinge or similar element 105 (providing stop points to position multi-grip handle 110) is provided at about 0 degrees, as illustrated in FIG. 1, about 24-45 degrees, about 45 degrees, and about 180 degrees. This permits multi-grip handle 110 to be positioned or repositioned for use with cutting edges 101, 102, 103, or others, such as surface 106, if surface 106 is provided with a cutting edge (smooth, serrated, etc.), as further described in connection with FIG. 3A-B.

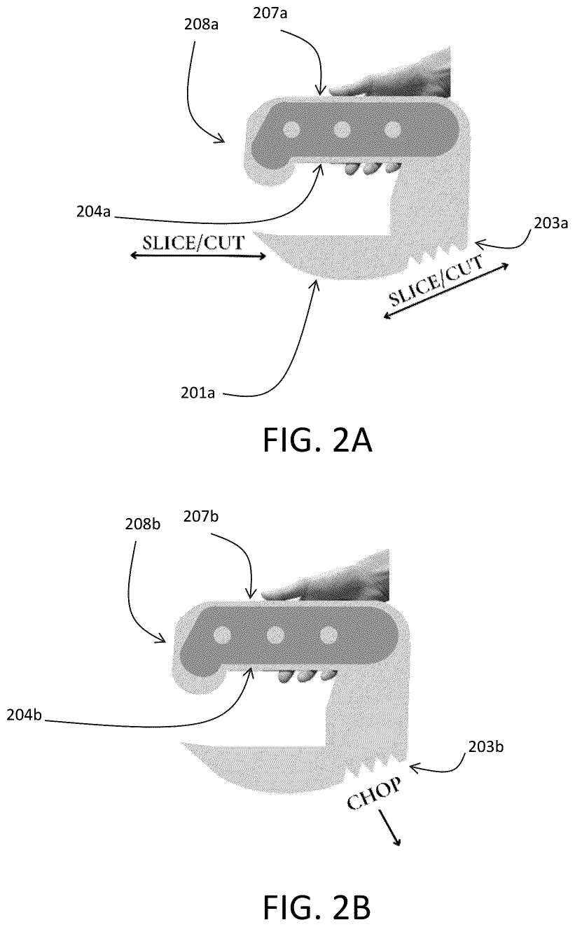

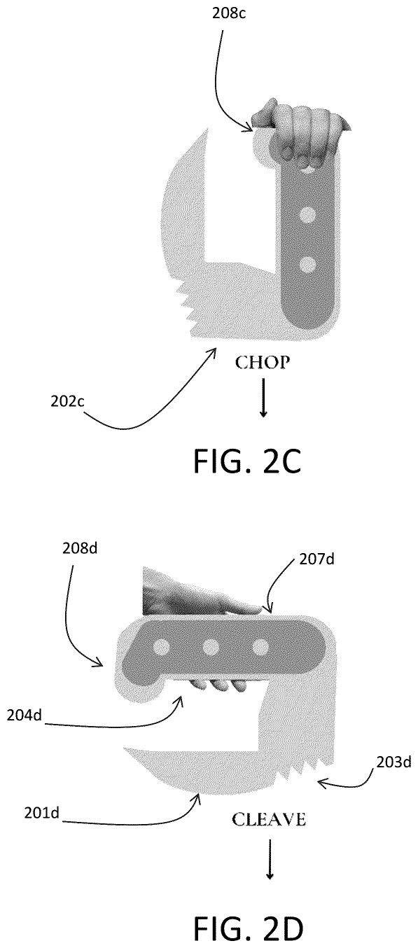

In an embodiment, multi-grip handle 110 may be grasped at grip surface 108 and used to chop with cutting edge 102, as further illustrated in FIG. 2C. In this orientation, a user rotates the cutting tool to position cutting surface 102 downward.

FIGS. 2A, 2B, 2C, and 2D each illustrate different possible grasping orientations and grip positions for use of multi-grip handle and multiple cutting surfaces. In the example of FIG. 2A, a user grasps multi-grip handle at grip surface 204a and grip surface 207a, with grip surface 208a positioned away from the user. As illustrated in FIG. 2A, this permits a user to slice or cut using cutting edge 201a or area 203a via simple repositioning of the wrist angle utilized. As shown in FIG. 2B, a user likewise grasps multi-grip handle at grip surfaces 204b and 207b, with grip surface 208b positioned away from the user as illustrated. This permits use of area 203b as a chopping surface, noting that a smooth cutting edge may be supplied in place of the illustrated toothed surface, and likewise area 203b may comprise one or more tools such as a bottle opener, a gut hook, a light emitting diode (LED) and power source, or similar fixed feature formed from or within the tool's material, which may include but is not limited to carbon steel. In the example where electronics or optical elements are included, for example an LED, a power source, such as a battery, may be included, such as within or on the multi-grip handle.

FIG. 2C illustrates a use of multi-grip handle where grip surface 208c is positioned toward the user's hand for grasping. This permits the user to utilize cutting edge 202c in a chopping motion as illustrated in FIG. 2C. As illustrated in FIG. 1 and FIG. 2C, grip surface 108, 208c may be formed as illustrated with an enlarged profile or width relative to the main width of multi-grip handle 110, facilitating grasping of gripping surface 108, 208c.

As shown in FIG. 2D, grip surface 208d may be oriented towards the user while the user grasps gripping surfaces 204d, 207d, in an opposite fashion as shown in FIG. 2A and FIG. 2B. This positioning permits a user to utilize multi-grip handle to cleave with surface 201d or 203d.

As described herein, multi-grip handle may be formed in a fixed fashion, e.g., multi-grip handle 110 may be integral to or formed from one continuous part, such as a single piece of steel. However, referring to FIG. 3A and FIG. 3B, in an embodiment an adjustable locking blade design may be utilized, for example with a release on multi-grip 310a, 310b. As shown in FIG. 3A-B, in an embodiment multi-grip handle 310a, 310b may be rotated about hinge 306a, 306b to expose surface 306a, 306b, which may include a cutting edge or tool. It is noted that other surfaces, such as surfaces 101, 102, and 103, may be fitted with cutting edges (e.g., smooth, serrated, etc.) as well as tool(s), as described herein. The actuation of hinge 305a, 305b may be mechanical, for example via use of a lock blade mechanism that permits repositioning of multi-grip handle 310a, 310b relative to surface 306a, 306b, as illustrated. This permits an additional cutting or tool surface 306a, 306b to be exposed for use, as shown.

As illustrated, an embodiment provides an improvement over conventional knife designs that feature a handle at one end of the cutting blade and improves traditional ulu design where the handle or grip is fixed in a central position about a single cutting surface. This provides the ability to include ergonomic gripping angles, which may be adjustable by virtue of multi-grip handle allowing multiple holding positions and/or repositioning or rotation of the multi-grip handle, as described herein.

An embodiment further provides multiple cutting edges or tool surfaces, acting as a multi-tool and allowing a user to perform multiple cutting, copping and cleaving actions with a single tool. This permits an embodiment to be more effective at cutting, slicing, and chopping while at the same time being easier to utilize, particularly for those with disabilities of the hand, wrist, and arm, making some traditional knife grips uncomfortable, particularly with repetitive motion. That is, a multi-grip tool as provided by an embodiment place less stress on the hand, wrists, arms, and elbow when compared to traditional cutting tools due to the various angles at which an embodiment may be grasped.

It is worth noting that while specific elements are illustrated in the figures, and a particular ordering or organization of elements or steps has been illustrated, these are non-limiting examples. In certain contexts, two or more elements or steps may be combined into an equivalent element or step, an element or step may be split into two or more equivalent elements or steps, or certain elements or steps may be re-ordered or re-organized or omitted as appropriate, as the explicit illustrated examples are used only for descriptive purposes and are not to be construed as limiting.

As used herein, the singular “a” and “an” may be construed as including the plural “one or more” unless clearly indicated otherwise.

The word “about” or similar relative term as applied to numbers includes ordinary (conventional) rounding of the number with a fixed base such as 5 or 10.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected by one skilled in the art without departing from the scope or spirit of the disclosure.

What is claimed is:

1. A cutting tool, comprising:
a multi-grip handle (110) including:
an end grip surface (108); and
a pair of grip surfaces (104, 107);
a connecting region having a first cutting edge (102);
the pair of grip surfaces being positioned between the end grip surface and the first cutting edge; and
a blade connected to the multi-grip handle via the connecting region and having a second cutting edge (101).

2. The cutting tool of claim 1, wherein the blade comprises a third cutting edge positioned between the first cutting edge and the second cutting edge.

3. The cutting tool of claim 1, wherein the blade, in a first position, runs parallel to the multi-grip handle and lengthwise away from the connection region underneath the multi-grip handle.

4. The cutting tool of claim 3, comprising a hinge disposed at an end of the multi-grip handle in the connecting region.

5. The cutting tool of claim 4, wherein the blade is repositionable about the hinge to angle towards and away from the multi-grip handle.

6. The cutting tool of claim 5, wherein the blade is repositionable with respect to the multi-grip handle at one or more predetermined angles.

7. The cutting tool of claim 6, wherein the one or more predetermined angles are within the range of about 20 degrees to about 45 degrees.

8. The cutting tool of claim 6, wherein the one or more predetermined angles is about 180 degrees.

9. The cutting tool of claim 8, comprising a fourth cutting edge disposed on the blade opposite to the second cutting edge.

10. The cutting tool of claim 1, comprising one or more tools disposed on one or more of the multi-grip handle, the connecting region, and the blade.

11. The cutting tool of claim 10, wherein the one or more tools include one or more of a bottle opener, a hook, and a light emitting diode (LED) operatively connected to a power source.

12. The cutting tool of claim 1, wherein the multi-grip handle is angled with respect to the blade in a fixed position.

13. The cutting tool of claim 12, wherein the fixed position is an angle in the range of about 20 degrees to about 45 degrees.

14. The cutting tool of claim 1, wherein the multi-grip handle comprises contouring.

15. The cutting tool of claim 14, wherein the contouring is defined by one or more of the pair of grip surfaces.

16. A cutting tool, comprising:
a handle including a pair of grip surfaces;
a connecting region;
a hinge; and
an ulu blade connected to handle via the connecting region and having a cutting edge;
the hinge being disposed at an end of the handle in the connecting region.

17. The cutting tool of claim 15, wherein the ulu blade is repositionable about the hinge to angle towards and away from the handle.

18. The cutting tool of claim 17, wherein the ulu blade is repositionable with respect to the handle at one or more predetermined angles within the range of about 20 degrees to about 180 degrees.

19. The cutting tool of claim 18, wherein the ulu blade comprises a second cutting edge opposite the cutting edge.

20. The cutting tool of claim 18, wherein the second cutting edge is one of smooth and serrated.
